(19) United States
(12) Patent Application Publication
(10) Pub. No.: US 2009/0190901 A1
(43) Pub. Date: Jul. 30, 2009

(54) VIDEO CONTENT REPRODUCTION DEVICE AND VIDEO CONTENT REPRODUCTION METHOD

(75) Inventor: Ryuichi Kitajima, Funabashi-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/356,292

(22) Filed: Jan. 20, 2009

(30) Foreign Application Priority Data
Jan. 28, 2008 (JP) 2008-016510

(51) Int. Cl. H04N 5/00

(52) U.S. Cl. 386/126; 386/E05.064

(57) ABSTRACT

According to one embodiment, to discriminate an optical disk having a DISCID.DAT file existing under an ADV_OBJ folder as compatible with an advanced standard, and discriminate a system of a video content by reading out system identification information (TV system) existing in a VTSI file under a TS folder of a high-density optical disk standard with respect to the optical disk. In case a video content reproduction device can reproduce a video content of the system, a reproduction processing sequence with respect to the optical disk compatible with the advanced standard is started.

### CROSS-REFERENCE TO RELATED APPLICATIONS

This application is based upon and claims the benefit of priority from Japanese Patent Application No. 2008-016510, filed Jan. 28, 2008, the entire contents of which are incorporated herein by reference.

### BACKGROUND

1. Field

One embodiment of the invention relates to a video content reproduction device and a video content reproduction method that automatically discriminate a system of an input video content.

2. Description of the Related Art

As is well known, in recent years, optical disks, such as a digital versatile disk (DVD), are widely used as digital recording media. Then, at present, an HD DVD-Video standard is completed as a next generation DVD standard compatible with a high-definition TV system, that is so-called high-definition (HD)-DVD that enables high-density recording better than DVD.

In this HD DVD-Video standard, four types of systems are specified to be adopted when a video content is recorded in an optical disk. The four types of systems are a national television system committee (NTSC) system, a phase alternation by line (PAL) system, a 50 Hz system that transmits video compatible with the high-definition TV system at 50 frames per second, and a 60 Hz system that transmits video compatible with the high-definition TV system at 60 frames per second.

In addition, in the HD DVD-Video standard, rather than a content of video or audio regulated by a current DVD-Video standard, an advanced content having more interactive function is defined. Then, in the HD DVD, there exist an advanced standard in which an advanced content is recorded and a normal standard in which a standard content other than an advanced content is recorded. The four types of systems described above are specified to be adopted for a video content with respect to each of the advanced standard and the normal standard.

For this reason, in an optical disk reproduction device that reproduces an HD DVD, a system of a video content recorded in an optical disk is discriminated after whether the video content is in the advanced standard or the normal standard is discriminated when the video content is reproduced. Then, the optical disk reproduction device switches internal setting so as to correspond to reproduction of a video content of the discriminated system. In case the optical disk reproduction device does not have a function of reproducing a video content of the discriminated system, an error is displayed and reproduction is stopped.

The optical disk reproduction device of the above kind reads out entire management information from an optical disk in order to read out management information of a title to be reproduced when a system of a video content is discriminated. Then, the optical disk reproduction device acquires information showing a system of the video content from the management information. For this reason, reading and analyzing processing for entire management information, and reading and analyzing processing for management information of a title to be reproduced are required. Accordingly, time is required to discriminate a system of the video content.

For this reason, the optical disk reproduction device requires time to discriminate whether a video content recorded in an optical disk can be reproduced or not. This results in inconvenience in use by the user.

Jpn. Pat. Appln. Publication No. 2002-290898 discloses a configuration of a DVD reproduction device that discriminates whether a DVD is an NTSC disk recording a video signal of the NTSC system or a PAL disk recording a video signal of the PAL system by reading out a variety of information files of the DVD mounted. In this manner, the DVD reproduction device can convert the readout video signal of any disk to a video signal of a system set by the user, and output the video signal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block configuration view showing an example of the present invention shown for explanation of an outline of an optical disk reproduction device;

FIG. 2 is a view shown for explanation of an optical disk in an advanced standard that is reproduced by the optical disk reproduction device in the example;

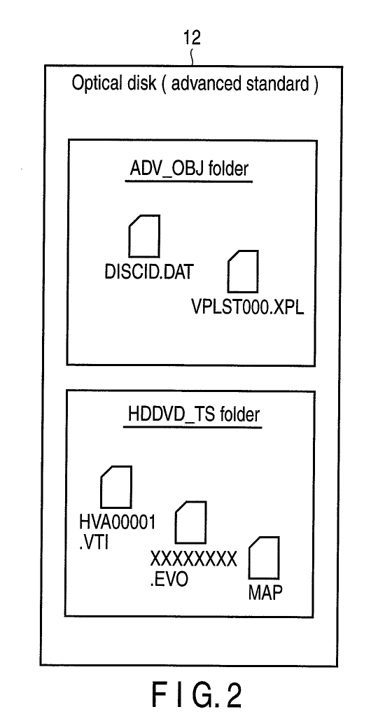

FIG. 3 is a view shown for explanation of VTS_EVOB_ATRT of an optical disk of the advanced standard in the example;

FIG. 4 is a view shown for explanation of VTS_EVOB_ATR in VTS_EVOB_ATRT in the example;

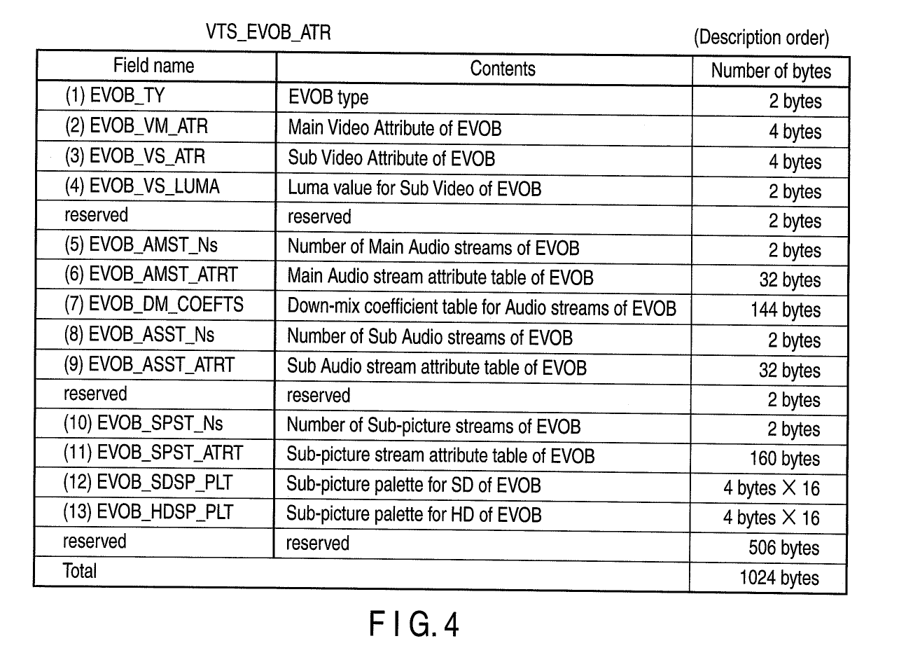

FIG. 5 is a view shown for explanation of EVOB_VM_ATR in VTS_EVOB_ATR in the example;

FIG. 6 is a view shown for explanation of an optical disk in the normal standard that is reproduced by the optical disk reproduction device in the example;

FIG. 7 is a view shown for explanation of VTSI of an optical disk of a normal standard in the example;

FIG. 8 is a view shown for explanation of VTSI_MAT in VTSI in the example;

FIG. 9 is a view shown for explanation of VTS_V_ATR in VTSI_MAT in the example;

FIG. 10 is a view shown for explanation of VMGI of an optical disk of the normal standard in the example;

FIG. 11 is a view shown for explanation of part of main processing operation that is executed by the optical disk reproduction device in the example; and

FIG. 12 is a flowchart shown for explanation of remaining part of the main processing operation that is executed by the optical disk reproduction device in the example.

### DETAILED DESCRIPTION

Various embodiments according to the invention will be described hereinafter with reference to the accompanying drawings. In general, according to one embodiment of the invention, to discriminate an optical disk having a DISCID.DAT file existing under an ADV_OBJ folder as compatible with an advanced standard, and discriminate a system of a video content by reading out system identification information existing in a VTSI file under a TS folder of a high-density optical disk standard with respect to the optical disk. In case a video content reproduction device can reproduce a video content of the system, a reproduction processing sequence with respect to the optical disk compatible with the advanced standard is started.

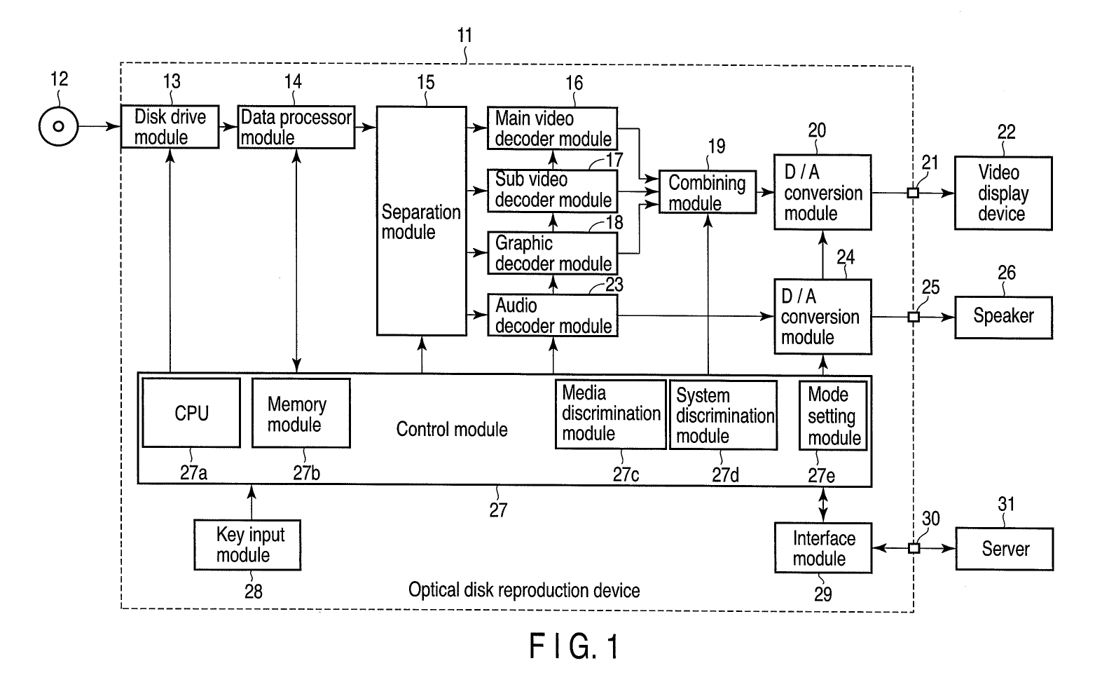

FIG. 1 shows an outline of an optical disk reproduction device 11 described in this example. The optical disk reproduction device 11 includes a disk drive module 13 that reads out a content recorded in an optical disk 12 (such as HD DVD, BD [Blue-ray Disk], or the like) compatible with a high-density optical disk standard that is mounted on the optical disk reproduction device 11. In the description described below, the HD DVD-Video Standard will be referred to as an example of the high-density disk standard.

A content read out by the disk drive module 13 is supplied to a separation module 15 through a data processor module 14. In this manner, the content is separated into a main video content, a sub video content, a graphic content, and an audio content.

Among the above contents, the main video content, the sub video content, and the graphic content are supplied to a main video decoder module 16, a sub video decoder module 17, and a graphic decoder module 18 corresponding to the contents respectively, and decoding processing is applied to the contents. Then, the contents output from the decoder modules 16 to 18 are supplied to a combining module 19 and are combined, and converted to analog at a digital/analog (D/A) conversion module 20. After that, the combined content is introduced to a video display device 22 through a video output terminal 21, and video thereof is displayed.

In addition, the audio content separated at the separation module 15 is supplied to an audio decoder module 23 and decoding processing is applied to the audio content. Then, after converted to analog at a D/A conversion module 24, the audio content is introduced to an external speaker 26 through an audio output terminal 25, and audio thereof is reproduced.

Here, all operation of the optical disk reproduction device 11, including reproduction operation of the optical disk 12 described above, is subject to centralized control by a control module 27. The control module 27 includes a central processing unit (CPU) 27a, and receives operation information from a key input module 28 and controls each module so that a content of such operation is reflected.

In this case, the control module 27 mainly uses a memory module 27b. The memory module 27b includes a read only memory (ROM) that stores a control program executed by the CPU 27a, a random access memory (RAM) that provides an operation area to the CPU 27a, and a non-volatile memory that stores variety of setting information, control information, and the like.

Also, the control module 27 can carry out data communication with a predetermined server 31, that is connected to an external network, through an interface module 29 and an input and output terminal 30. In the above manner, the control module 27 can access the server 31 and acquire a desired content, program, and the like from the server 31. In this case, a content acquired from the server 31 is supplied to the data processor module 14, and then is used for video display and audio reproduction described above.

Further, the control module 27 includes a media discrimination module 27c, a system discrimination module 27d, and a mode setting module 27e. The media discrimination module 27c discriminates whether the optical disk 12 mounted in the disk drive module 13 is in conformity with the advanced standard or the normal standard.

In this case, the media discrimination module 27c discriminates the optical disk 12 as in the advanced standard when an ADV(advanced)_OBJ(object) folder exists in the optical disk 12 and a DISCID.DAT file exists under the ADV_OBJ folder. In addition, the media discrimination module 27c discriminates the optical disk 12 as in the normal standard when the ADV_OBJ folder does not exist in the optical disk 12 or the DISCID.DAT file does not exist under the ADV_OBJ folder, and an HV000I01.IFO file exists under an HDDVD_TS folder.

In addition, the system discrimination module 27d discriminates whether a video content recorded in the optical disk 12 is in any of the NTSC system, the PAL system, the 50 Hz system, and the 60 Hz system on the basis of a result of the discrimination of whether the optical disk 12 is in the advanced standard or the normal standard carried out by the media discrimination module 27c, before a normal reproduction processing sequence with respect to the optical disk 12 is started. Detailed description with respect to such discrimination will be made later.

Further, the mode setting module 27e switches internal setting of the optical disk reproduction device 11 so as to correspond to reproduction of a video content in the system discriminated by the system discrimination module 27d. For example, synchronous clock frequencies of each of the decoder modules 16 to 18 are set to frequencies corresponding to the system discriminated by the system discrimination module 27d. In case the optical disk reproduction device 11 does not have a function of reproducing a video content of the system discriminated by the system discrimination module 27d, the mode setting module 27e controls the video display device 22 to display an error, and controls reproduction to be stopped.

Here, the discrimination processing of a system of a video content carried out by the system discrimination module 27d will be described more specifically. First, description will be made with respect to a case where the media discrimination module 27c discriminates that the optical disk 12 is in the advanced standard. In the optical disk 12 in the advanced standard, there exist the ADV_OBJ folder and the HDDVD_TS(transport stream) folder.

Then, in the ADV_OBJ folder, the DISCID.DAT file exists as described above, and also a VPLST000.XPL file which is a playlist exists as well. Moreover, the HDDVD_TS folder includes an HVA00001.VTI file indicating attribute information relating to video, an XXXXXXXX.EVO file as actual video information, and a MAP file indicating positions of a variety of information.

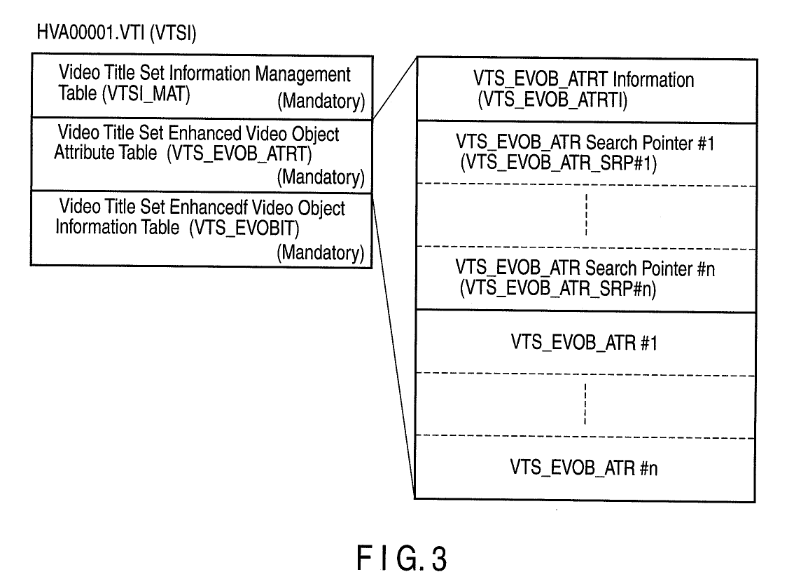

Among the above files, the HVA0001.VTI file is video title set information (VTSI) as shown in FIG. 3, and describes VTSI_MAT (management table), VTS_EVOB(enhanced video object)_ATRT(attribute table), and VTS_EVOBIT(enhanced video object information table).

Then, the VTS_EVOB_ATRT includes VTS_EVOB_ATR_SRPs (search pointers) #1 to #n as many as the number of titles, and VTS_EVOB_ATRs #1 to #n describing actual attribute information of the titles at positions indicated by the VTS_EVOB_ATR_SRPs#1 to #n.

Here, one VTS_EVOB_ATR includes EVOB_TY, EVOB_VM_ATR, EVOB_VS_ATR, EVOB_VS_LUMA, EVOB_AMST_Ns, EVOB_AMST_ATRT, AVOB_DM_COEFTS, EVOB_ASST_Ns, EVOB_ASST_ATRT, EVOB_SPST_Ns, EVOB_SPST_ATRT, EVOB_SDSP_PLT, EVOB_HDSP_PLT, and the like.

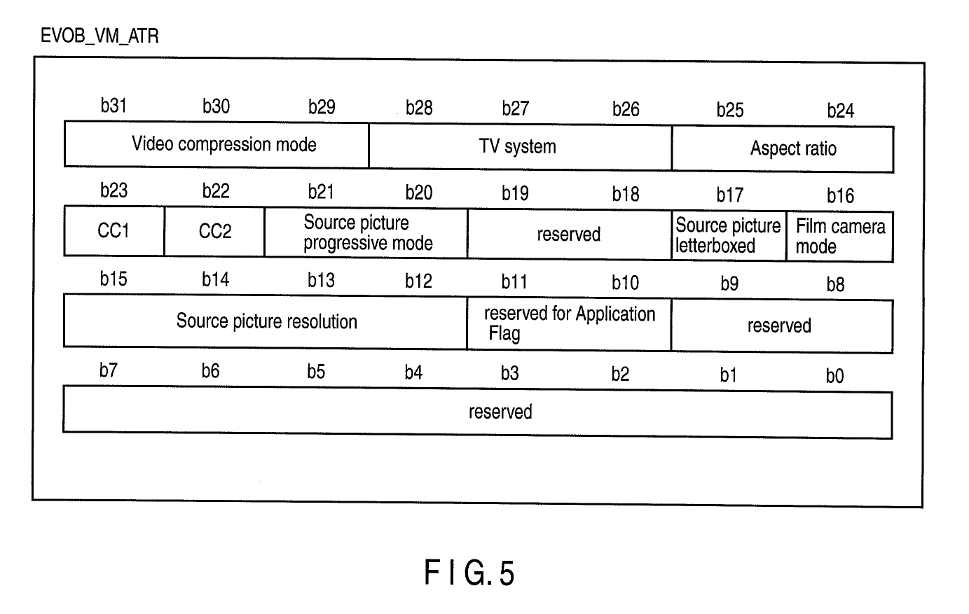

Among the above, EVOB_VM(main video)_ATR describes TV (television) system information of 3 bits (b28 to b26) as shown in FIG. 5. The TV system information is identification information indicating a system of a video content in the advanced standard. That is, the TV system information indicates the NTSC system when “000b(binary)”, indicates the PAL system when “001b”, indicates the 60 Hz system when “010b”, and indicates 50 Hz system when “011b”.

For the above reason, in case the media discrimination module 27c discriminates that the optical disk 12 is in the advanced standard, the system discrimination module 27d reads the HVA00001.VTI file (VTSI) under the HDDVD_TS folder, discriminates a system of a video content from EVOB_VM_ATR of first VTS_EVOB_ATR#1, and outputs a result of the discrimination to the mode setting module 27e.

EVOB_VM_ATRs of the other VTS_EVOB_ATR#2 to #n describe the TV system information that is same as EVOB_VM_ATR of VTS_EVOB_ATR#1. For the above reason, in order to discriminate a system of a video content, only the TV system information thereof needs to be read out from EVOB_VM_ATR of one VTS_EVOB_ATR#1.

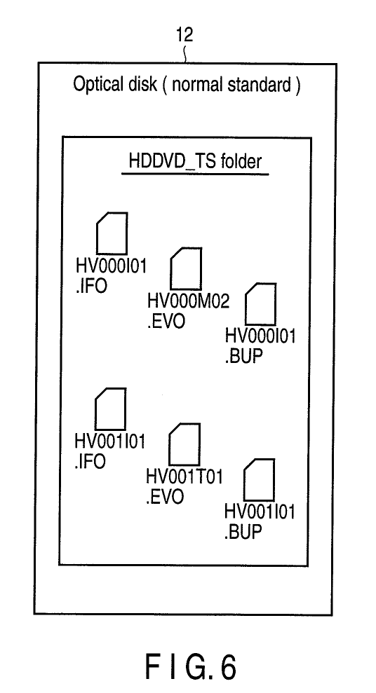

On the other hand, description will be made with respect to a case where the media discrimination module 27c discriminates that the optical disk 12 is in the normal standard. In the optical disk 12 in the normal standard, there exists an HDDVD_TS folder as shown in FIG. 6.

Then, the HDDVD_TS folder includes an HV000I01.IFO file showing entire management information of the optical disk 12, an HV000M02.EVO file showing management information of an entire video content recorded in the optical disk 12, and an HV000I01.BUP file that backs up these files.

Also, the HDDVD_TS folder includes HV001I01.IFO files that exist as many as the number of titles and indicate attribute information relating to video of the title, HV001T01.EVO files that exist as many as the number of titles and serve as actual video information for the titles, and an HV0001I01.BUP file that backs up these files.

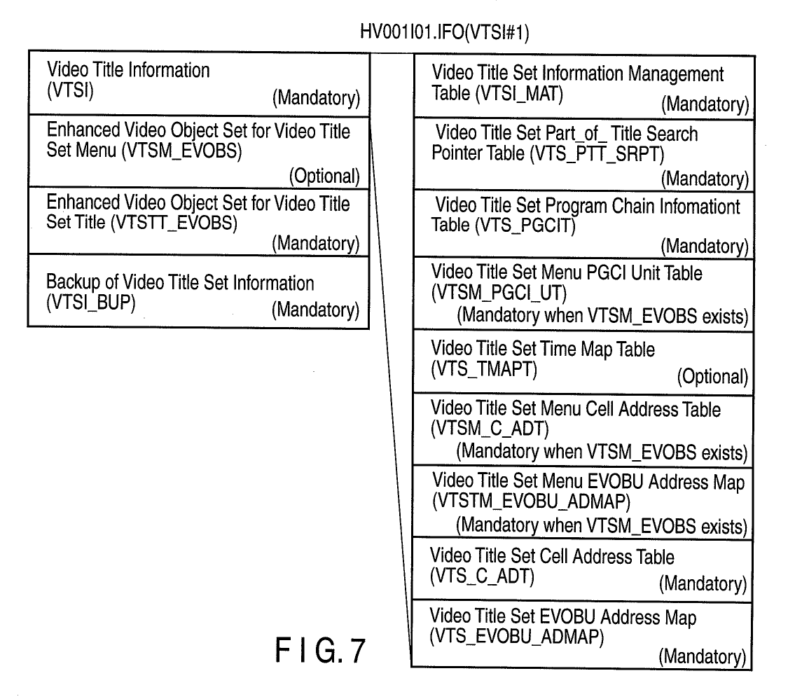

Among the above files, one HV0001I01.IFO file is VTSI#1 as shown in FIG. 7, and describes VTSI_MAT, VTS_PTT(part of title)_SRPT(search pointer table), VTS_PGCIT(program chain information table), VTSM(video title set menu)_PGCI_UT(unit table), VTS_TMAPT(time map table), VTSM_C(cell)_ADT(address table), VTSM_EVOBU(enhanced video object unit)_ADMAP(address map), VTS_C_ADT, and VTS_EVOBU_ADMAP.

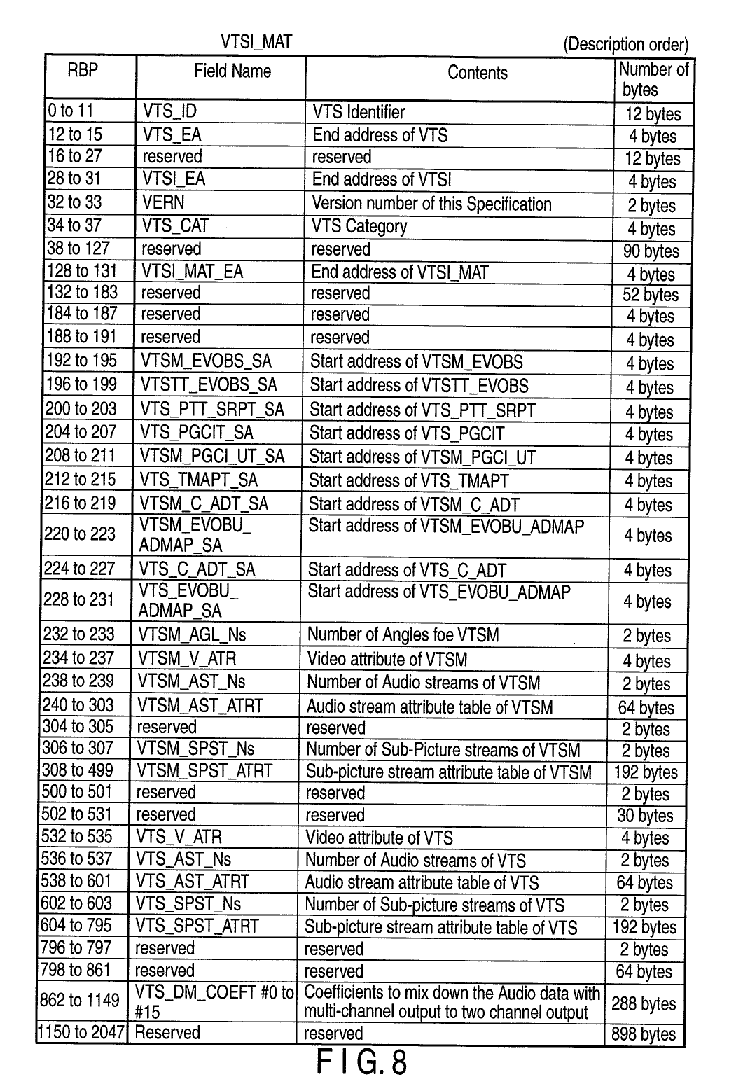

Then, as shown in FIG. 8, VTSI_MAT includes VTS_ID, VTS_EA, VTSI_EA, VERN, VTS_CAT, VTSI_MAT_EA, VTSM_EVOBS_SA, VTSTT_EVOBS_SA, VTS_PTT_SRPT_SA, VTS_PGCIT_SA, VTSM_PGCI_UT_SA, VTS_TMAPT_SA, VTSM_C_ADT_SA, VTSM_EVOBU_ADMAP_SA, VTS_C_ADT_SA, VTS_EVOBU_ADMAP_SA, VTSM_AGL_Ns, VTSM_V_ATR, VTSM_AST_Ns, VTSM_AST_ATRT, VTSM_SPST_Ns, VTSM_SPST_ATRT, VTS_V_ATR, VTS_AST_Ns, VTS_AST_ATRT, VTS_SPST_Ns, VTS_SPST_ATRT, VTS_DM_COEFT#0 to #15, and the like.

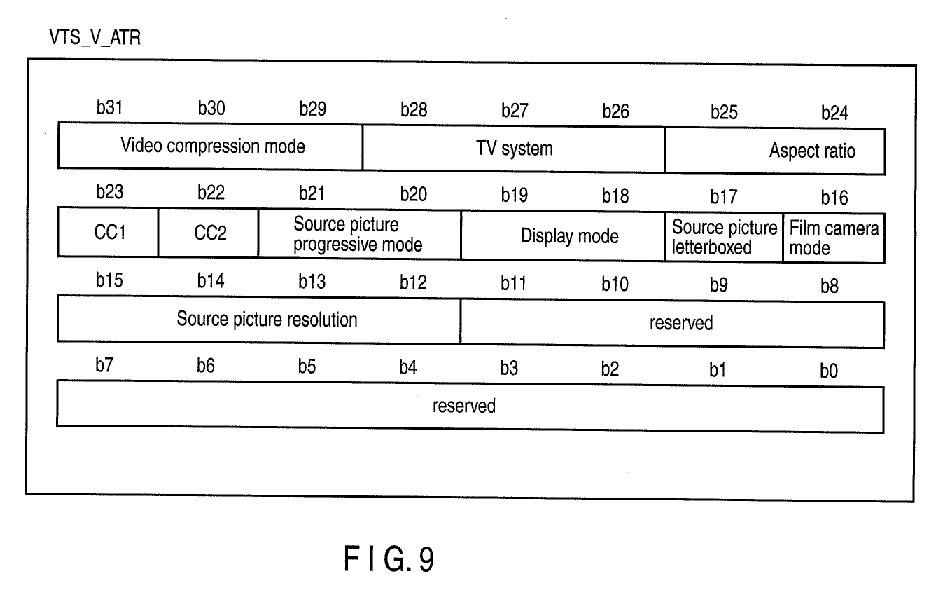

Among the above, VTS_V(video)_ATR describes TV system information of 3 bits (b28 to b26) as shown in FIG. 9. The TV system information is identification information indicating a system of a video content in the normal standard. That is, the TV system information indicates the NTSC system when “000b(binary)”, indicates the PAL system when “001b”, indicates the 60 Hz system when “010b”, and indicates 50 Hz system when “011b”.

For the above reason, in case the media discrimination module 27c discriminates that the optical disk 12 is in the normal standard, the system discrimination module 27d reads the first HV001I01.IFO file (VTSI#1 file) under the HDDVD_TS folder, discriminates a system of a video content from VTS_V_ATR of the VTSI_MAT, and outputs a result of the discrimination to the mode setting module 27e.

HV001I01.IFO files other than VTSI#1 also describe the TV system information same as that of VTSI#1. For the above reason, in order to discriminate a system of a video content, only the TV system information thereof needs to be read out from one HV001I01.IFO file (VTSI#1 file).

In addition, in order to discriminate a system of a video content in the optical disk 12 in the normal standard, there is a method as described above, other than a means for reading out VTSI_MAT from the HV001I01.IFO file (VTSI#1) under the HDDVD_TS folder and acquiring the TV system information in VTS_V_ATR thereof as described above.

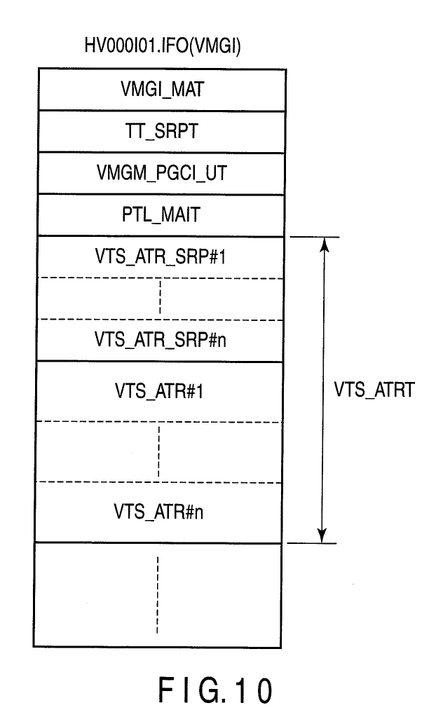

That is, the HV000I01.IFO file existing under the HDDVD_TS folder is a video manager information (VMGI) file as shown in FIG. 10, and describes VMGI_MAT, TT_SRPT, VMGM_PGCI_UT, PLT_MAIT, VTS_ATRT, and the like.

Then, the VTS_ATRT includes VTS_ATR_SRPs#1 to #n as many as the number of titles, and VTS_ATRs #1 to #n describing actual attribute information of the titles at positions indicated by the VTS_ATR_SRP#1 to #n. Among the above, one VTS_ATR#1 describes TV system information of 3 bits (b28 to b26) as shown in FIG. 9. A system of a video content in the normal standard can be discriminated also by the TV system information.

For the above reason, in case the media discrimination module 27c discriminates that the optical disk 12 is in the normal standard, the system discrimination module 27d reads the HV000I01.IFO file (VMGI file) under the HDDVD_TS folder, discriminates a system of a video content from VTS_ATR#1 thereof, and outputs a result of the discrimination to the mode setting module 27e.

VTS_ATR#2 to #n other than VTS_ATR#1 also describe the TV system information same as that of VTS_ATR#1. For the above reason, in order to discriminate a system of a video content, only the TV system information thereof needs to be read out from one VTS_ATR#1.

When the system discrimination module 27d discriminates a system of a video content recorded in the optical disk 12 as described above, and in case the optical disk reproduction device 11 has a function of reproducing a video content of a system discriminated by the system discrimination module 27d, the mode setting module 27e switches internal setting of the optical disk reproduction device 11 so as to correspond to reproduction of a video content in the system.

After the above, the control module 27 starts a normal reproduction processing sequence with respect to the optical disk 12. That is, the control module 27 reads out entire management information, management information of a title to be reproduced, and the like from the optical disk 12, and executes normal reproduction processing for reproducing a title on the basis of a playlist and the like.

Also, in case the optical disk reproduction device 11 does not have a function of reproducing a video content of the system discriminated by the system discrimination module 27d, the mode setting module 27e controls the video display device 22 to display an error, and controls reproduction of the video content to be stopped.

According to the example described above, a system of a video content is discriminated by reading the TV system information from the optical disk 12 before a normal reproduction processing sequence with respect to the optical disk 12 is started. Accordingly, a system of a video content recorded in the optical disk 12 is discriminated in a short period of time in order to carry out discrimination as to whether the optical disk reproduction device 11 can reproduce the video content or not promptly. In this manner, convenience to the user can be improved.

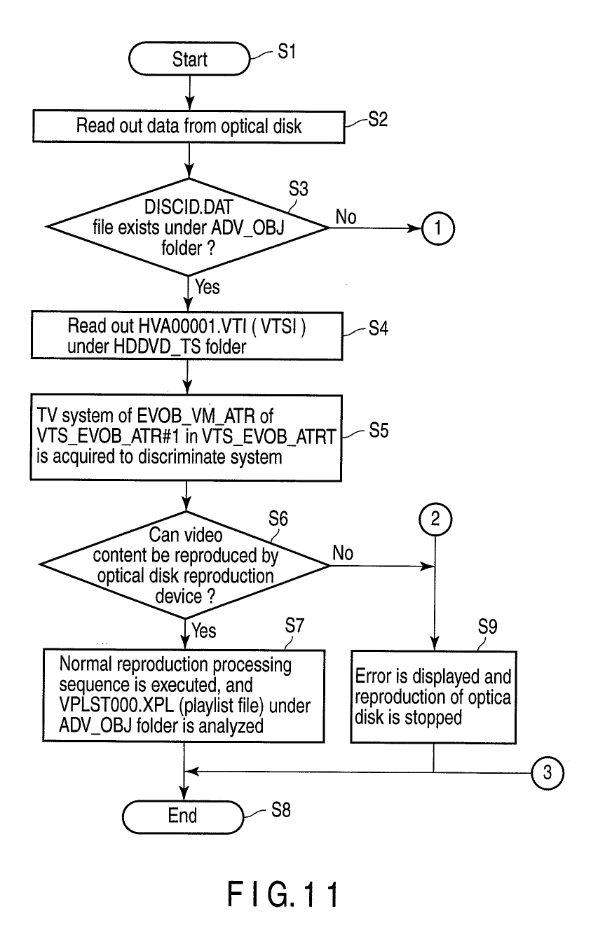

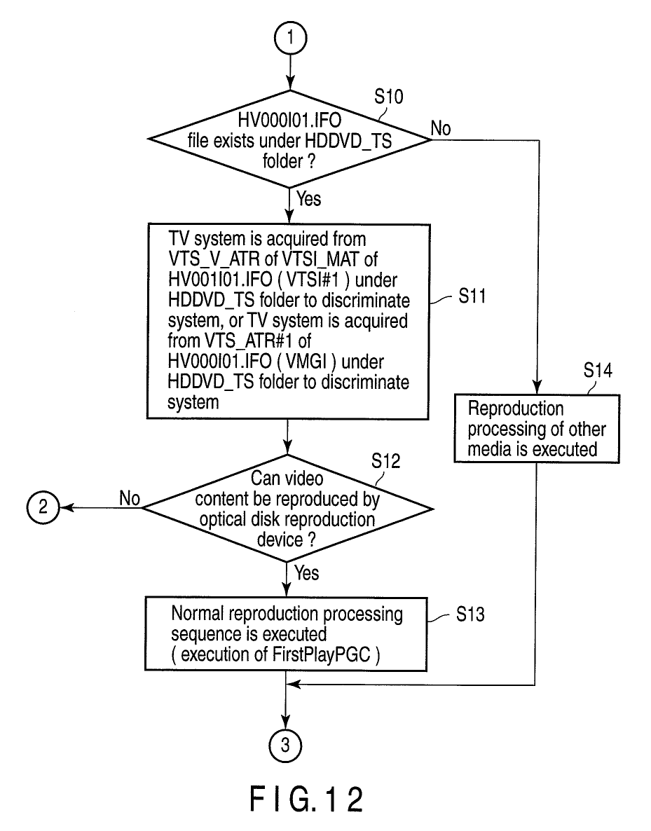

FIGS. 11 and 12 show flowcharts that summarize main processing operation carried out by the control module 27 of the optical disk reproduction device 11 described above. That is, the processing is started (Step S1) when the optical disk 12 is mounted on the disk drive module 13. Then, the control module 27 controls the disk drive module 13 to read out data from the optical disk 12 in Step S2. In Step S3, the control module 27 discriminates whether the ADV_OBJ folder exists in the optical disk 12 and the DISCID.DAT file exists under the ADV_OBJ folder or not.

Then, in case the DISCID.DAT file is determined to exist under the ADV_OBJ folder (YES), the control module 27 determines that the optical disk 12 is in conformity with the advanced standard, and reads the HVA00001.VTI file (VTSI) under the HDDVD_TS folder in Step S4. Then, in Step S5, the control module 27 acquires the TV system information from EVOB_VM_ATR of first VTS_EVOB_ATR#1 in VTS_EVOB_ATRT thereof to discriminate a system of a video content.

After the above, in Step S6, the control module 27 compares the system discriminated previously and specifications of the optical disk reproduction device 11 recorded in a non-volatile memory and the like of the memory module 27b, and discriminates whether the optical disk reproduction device 11 has a function of reproducing a video content of the system.

Then, in case the optical disk reproduction device 11 is determined to be able to reproduce a video content of the system (YES), the control module 27 executes a normal reproduction processing sequence [analysis of a VPLST000.XPL file (playlist file) under the ADV_OBJ folder, and the like] with respect to the optical disk 12 in the advanced standard in Step S7. Then, the processing ends (Step S8).

In addition, in case the optical disk reproduction device 11 is determined to be unable to reproduce the video content in the above Step S6 (NO), the control module 27 controls the video display device 22 to display an error and stops reproduction of the optical disk 12 in Step S9. Then, the processing ends (Step S8).

On the other hand, in case the ADV_OBJ folder is determined not to exist in the optical disk 12, or the DISCID.DAT file is determined not to exist under the ADV_OBJ folder in the above Step S3 (NO), the control module 27 discriminates whether the HV000I01.IFO file (VMGI file) exists or not under the HDDVD_TS folder in Step S10. In case the HV000I01.IFO file is determined to exist (YES), the optical disk 12 is determined to be in conformity with the normal standard.

Then, in Step S11, the control module 27 reads the first HV001I01.IFO file (VTSI#1 file) under the HDDVD_TS folder and acquires the TV system information from VTS_V_ATR of VTSI_MAT thereof to discriminate a system of a video content, or the control module 27 reads the HV000I01.IFO file (VMGI file) under the HDDVD_TS folder and acquires the TV system from VTS_ATR#1 thereof to discriminate a system of a video content.

After the above, in Step S12, the control module 27 compares the system discriminated previously and specifications of the optical disk reproduction device 11 recorded in a non-volatile memory and the like of the memory module 27b, and discriminates whether the optical disk reproduction device 11 has a function of reproducing a video content of the system.

Then, in case the optical disk reproduction device 11 is determined to be able to reproduce a video content of the system (YES), the control module 27 executes a normal reproduction processing sequence [processing of a FirstPlayPGC file, and the like] with respect to the optical disk 12 in the normal standard in Step S13. Then, the processing ends (Step S8).

In addition, in case the optical disk reproduction device 11 is determined to be unable to reproduce the video content in the above Step S12 (NO), the control module 27 controls the video display device 22 to display an error and stops reproduction of the optical disk 12 in Step S9. Then, the processing ends (Step S8).

Further, in case the HV000I01.IFO file (VMGI file) is not determined to exist under the HDDVD_TS folder in the above Step S10 (NO), the control module 27 executes reproduction processing of a content acquired from other media, such as the server 31 in Step S14. Then the processing ends (Step S8).

Here, in case the optical disk reproduction device 11 is a model exclusively used for reproducing a video content of the NTSC (60 HZ) system, a video content can be reproduced as it is if the discriminated system is in conformity with 60 fps. In case the discriminated system is in conformity with 50 fps, an error is displayed and reproduction is stopped.

In addition, in case the optical disk reproduction device 11 is a model exclusively used for reproducing a video content of the PAL (50 HZ) system, a video content can be reproduced as it is if the discriminated system is in conformity with 50 fps. In case the discriminated system is in conformity with 60 fps, an error is displayed and reproduction is stopped.

Further, in case the optical disk reproduction device 11 is a model that is in conformity with reproduction of a video content in both the NTSC (60 Hz) system and the PAL (50 Hz) system, a video content can be reproduced by setting synchronous frequencies to 60 Hz when the discriminated system is in conformity with 60 fps. When the discriminated system is in conformity with 50 fps, the synchronous frequencies can be set to 50 Hz in order to reproduce a video content.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video content player configured to playback a video content recorded in an optical disk compliant with a high-density optical disk standard, comprising:
a first disk identification module configured to identify the optical disk as an optical disk compatible with a second standard advanced to a first standard, if a configuration file is under a folder for configurations and scripting with respect to the optical disk;
a first system identification module configured to identify a system of a video content by reading identification information indicating a system of a main video content in a file of information of video title sets under a folder of title sets of the high-density optical disk standard, with respect to the optical disk identified as compatible with the second standard by the first disk identification module; and
a first reproduction identification module configured to start a playback sequence with respect to the optical disk compatible with the second standard, when the video content player is configured to playback a video content in the system identified by the first system identification module.

2. The video content player of claim 1, wherein
the first system identification module is configured to identify a system of a video content by reading out a TV system in a data indicative of main video attributes of an enhanced video object comprised in a data area corresponding to video title set enhanced video object attributes in a table comprising video title set enhanced video object attributes in the file of information of video title sets.

3. The video content player of claim 1, wherein
the first reproduction identification module is configured to compare the system identified by the first system identification module and system information of the video content player and to determine whether the video content player is configured to playback a video content with the system.

4. The video content player of claim 1, wherein
the first reproduction identification module is either configured to analyze a playlist file if the video content player is configured to playback a video content with the system identified by the first system identification module, or configured to control an indication on a display in order to inform that the video content player is not configured to playback a video content with the system identified by the first system identification module and configured to stop playback of the optical disk.

5. The video content player of claim 1, further comprising:
a second disk identification module configured to identify the optical disk as an optical disk compatible with the first standard, if a file of video manager information is under the folder of title sets the high-density optical disk standard, with respect to the optical disk not identified as compatible with the second standard by the first disk identification module;
a second system identification module configured to identify a system of a video content by reading identification information indicating a system of a video content under the folder of title sets of the high-density optical disk standard, with respect to the optical disk identified as compatible with the first standard by the second disk identification module; and
a second reproduction identification module configured to start a playback sequence with respect to the optical disk compatible with the first standard, if the video content player is configured to playback a video signal with the system identified by the second system identification module.

6. The video content player of claim 5, wherein
the second system identification module is configured to identify a system of a video content by reading out a TV system in a data of video attributes of video title sets in a table of video title set information management in the file of information of video title sets.

7. The video content player of claim 5, wherein
the second system identification module is configured to identify a system of a video content by reading out a TV system in a data of video title set attributes in a table of video title set attributes in the file of video manager information under the folder of title sets of the high-density optical disk standard.

8. The video content player of claim 5, wherein
the second reproduction identification module is either configured to execute First Play Program Chain if the video content player is configured to playback a video content with the system identified by the second system identification module, or configured to control an indication on a display in order to inform that the video content player is not configured to playback a video content with the system identified by the second system identification module and configured to stop playback of the optical disk.

9. A video content playback method of playing back a video content recorded in an optical disk compliant with a high-density optical disk standard, comprising:
identifying the optical disk as an optical disk compatible with a second standard advanced to a first standard, when a configuration file is under a folder for configurations and scripting, with respect to the optical disk;
identifying a system of a video content by reading out identification information indicating a system of a main video content in a file of video title set information under a folder of title sets of the high-density optical disk standard, with respect to the optical disk identified as in compatible with the second standard; and
starting a playback sequence with respect to the optical disk compatible with the second standard, if a video content player is configured to playback a video content of the identified system.

10. The video content reproduction method of claim 9, further comprising:
identifying the optical disk as an optical disk compatible with a first standard, in case a file of video manager information is under the folder of title sets of the high-density optical disk standard, with respect to the optical disk identified as not compatible with the second standard;
identifying a system of a video content by reading out identification information indicating a system of a video content under the folder of title sets of the high-density optical disk standard, with respect to the optical disk identified as compatible with the first standard; and
starting a playback sequence with respect to the optical disk compatible with the first standard, if the video content player is configured to playback a video content of the identified system.
